(19) United States
(12) Patent Application Publication
(10) Pub. No.: US 2003/0171931 A1
(43) Pub. Date: Sep. 11, 2003

(54) System for creating user-dependent recognition models and for making those models accessible by a user

(76) Inventor: Eric I-Chao Chang, Beijing (CN)

Correspondence Address: WESTMAN CHAMPLIN & KELLY, International Centre, Suite 1600, 900 South Second Avenue, Minneapolis, MN, 55402-3319, US

(21) Appl. No.: 10/095,331

(22) Filed: Mar. 11, 2002

(51) Int. Cl. G10L 21/00

(52) U.S. Cl. 704/275; 704/1

(57) ABSTRACT

The present invention trains a user recognition model for a user. A user enrollment input is received and one or more cohort models are identified from a set of possible cohort models. The cohort models are identified based on a similarity measure between the set of possible cohort models and the user enrollment input. Once the cohort models have been identified, a user model is generated based on data associated with the identified cohort models.

### BACKGROUND OF THE INVENTION

The present invention relates to recognition of a user input (such as speech). More specifically, the present invention relates to generating a recognition model (such as an acoustic model) customized to a user without the user being required to provide substantial enrollment data.

Speech is a natural way for people to communicate. It is believed that speech will play an ever increasing role in human-computer interfaces in the future. Speech provides advantages, such as allowing faster input than other input devices, reducing the need to learn typing skills, and allowing interaction with devices that do not have a built-in keyboard. However, as yet, speech-based systems have not achieved wide-spread use.

It is believed that one barrier to the wide-spread use of speech in human-computer interfaces is the lack of robustness and recognition accuracy in current speech recognition systems. Such current systems typically employ language models and acoustic models. One popular language model is an n-gram language model that predicts a current word, given its history of n-1 words. An acoustic model models the acoustics associated with speech utterances. An acoustic model is a statistically generated acoustic probability model that provides a probability of a given acoustic utterance, given an input signal.

Speaker-dependent acoustic models are acoustic models that are trained (or adapted) based substantially on speech samples from the speaker who is to use the recognition system employing the speaker-dependent acoustic model. Speaker-independent models are customarily trained based on a wide variety of data from a wide variety of speakers.

It is widely known that speaker-dependent acoustic models perform much better for the speaker for which they were trained than a speaker-independent model. Therefore, in order to improve the accuracy of speech recognition systems, most current dictation programs require a new user to undergo an enrollment process before actually using the system. During the enrollment process, the user is requested to speak anywhere between 10 sentences and hundreds of sentences so that the system has a sufficient number of speech wave forms from the user to attempt to customize the acoustic model to the user. However, this process can take up to several hours, and can be an impediment for many people to even try a speech-recognition system.

Thus, different ways of dealing with speaker variably have been one of the most important research areas in speech recognition. The speaker differences can result from the configuration of the vocal cord and the vocal tract, dialectal differences, and differences in speaking style.

One of the ways which has been attempted in the past to deal with speaker variability is speaker adaptation. In the speaker adaptation technique, the parameters in the acoustic model are modified according to some adaptation data.

Another method of dealing with speaker variability includes speaker normalization. Speaker normalization attempts to map all speakers in the training set to one canonical speaker.

Still another way of dealing with speaker variability includes speaker data boosting. This method attempts to artificially increase the amount of speaker variability in the training data base.

However, these systems do not address the problem of requiring a fairly large amount of enrollment data from a speaker. One system that has been directed to this problem is referred to as speaker clustering. In accordance with that method, speakers are clustered in advance of receiving any data from a user. Each time additional training data becomes available, the initial cluster definition must be reconstructed. This can be extremely difficult when training data is collected gradually and intermittently.

Yet another system directed to solving this problem is based on the selection of a reference speaker. A small number of individual speakers are chosen as reference speakers and a small number of statistics (such as mean vectors and eigenvoices) are used to represent the reference speakers and construct different acoustic models adapted for speakers by a weighted combination scheme. While this system is efficient for implementation, its success is highly dependent on whether these few statistics are sufficient for describing the distribution of the reference speakers. In other words, the results of such a system are highly sensitive to both the choice of reference speakers and the accuracy of the estimation of the statistics.

### SUMMARY OF THE INVENTION

The present invention trains a user recognition model for a user. A user enrollment input is received and one or more cohort models are identified from a set of possible cohort models. The cohort models are identified based on a similarity measure between the set of possible cohort models and the user enrollment input. Once the cohort models have been identified, a user model is generated based on data associated with the identified cohort models.

The similarity between the cohort models and the user enrollment input can be determined in a number of different ways. For example, acoustic models are statistically generated acoustic probability models and can thus be operated in a generative mode. Thus, in order to determine similarity between cohort models and the user enrollment input, the cohort acoustic models are operated in the generative mode to generate the user enrollment input in order to measure the likelihood that the model will generate that input.

The similarity can also be obtained using syllable transcription and alignment. In that embodiment, the user enrollment input is decoded by different possible cohort acoustic models and the accuracy of the decoded syllables is compared against a syllable transcription of the user enrollment input.

In another embodiment, both the likelihood criteria and the syllable accuracy criteria are used in identifying cohort acoustic models.

The present invention can also be implemented as a system for training a custom user recognition model or user acoustic model, and the principles of the present invention can be applied outside speech, to other technologies (such as, for example, the recognition of handwriting) as well.

### BRIEF DESCRIPTION OF THE DRAWINGS

FIG. 1 is a block diagram of an illustrative environment in which the present invention may be used.

FIG. 2 is a more detailed block diagram of a system in accordance with one embodiment of the present invention.

FIG. 3 is a flow diagram illustrating one embodiment of the operation of the present invention.

FIG. 4 is a block diagram illustrating the delivery of a custom model in accordance with one embodiment of the present invention.

FIG. 5 is a flow diagram illustrating one embodiment of determining similarity between a user enrollment input and a possible cohort model.

FIG. 6 is a flow diagram illustrating another embodiment of determining similarity between a user enrollment input and a possible cohort model.

FIG. 7 is a flow diagram illustrating one embodiment of generating a custom acoustic model in accordance with one embodiment of the present invention.

### DETAILED DESCRIPTION OF ILLUSTRATIVE EMBODIMENTS

The present invention generates a custom user model for the recognition of a user input, while only requiring a very small amount of user enrollment data. The present invention compares the enrollment data against a plurality of different possible cohort models to identify cohort models which are closest to the user enrollment data. The data corresponding to the cohort models is used to generate a custom model for the user. While the present invention is discussed below with respect to acoustic models in a speech recognition system, it can be equally applied to other areas as well, such as to the recognition of a handwriting input, for example. The present invention also makes the custom model accessible to the user in one of a variety of different ways, such as by downloading it to a user designated device over a global network, or such as by simply storing the custom model on the global network so that it can be accessed by the user at a later time.

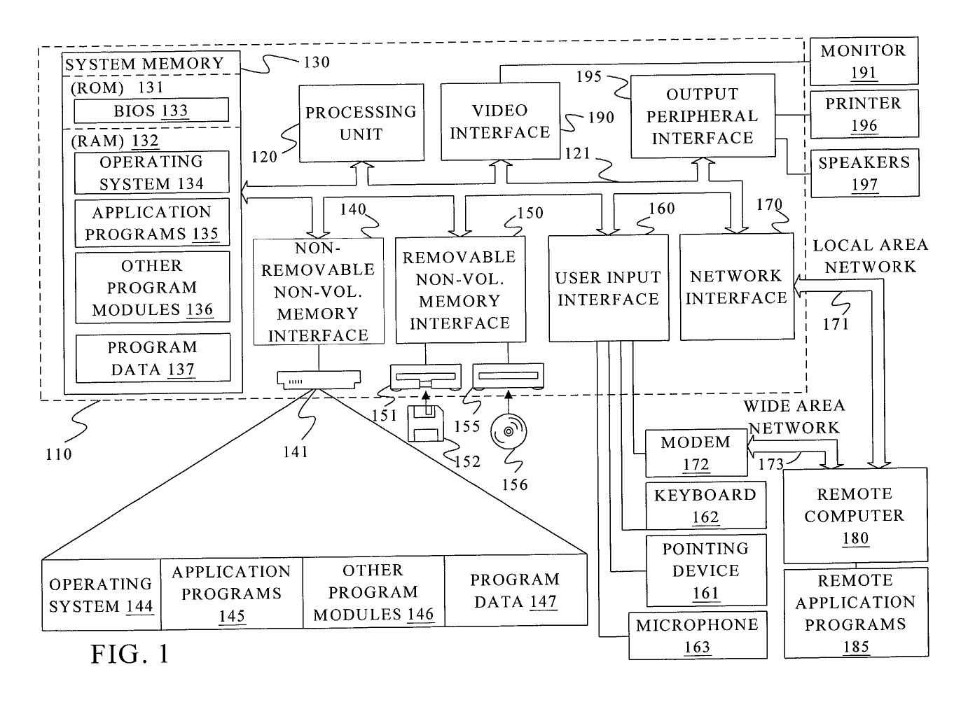

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way o example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147, are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

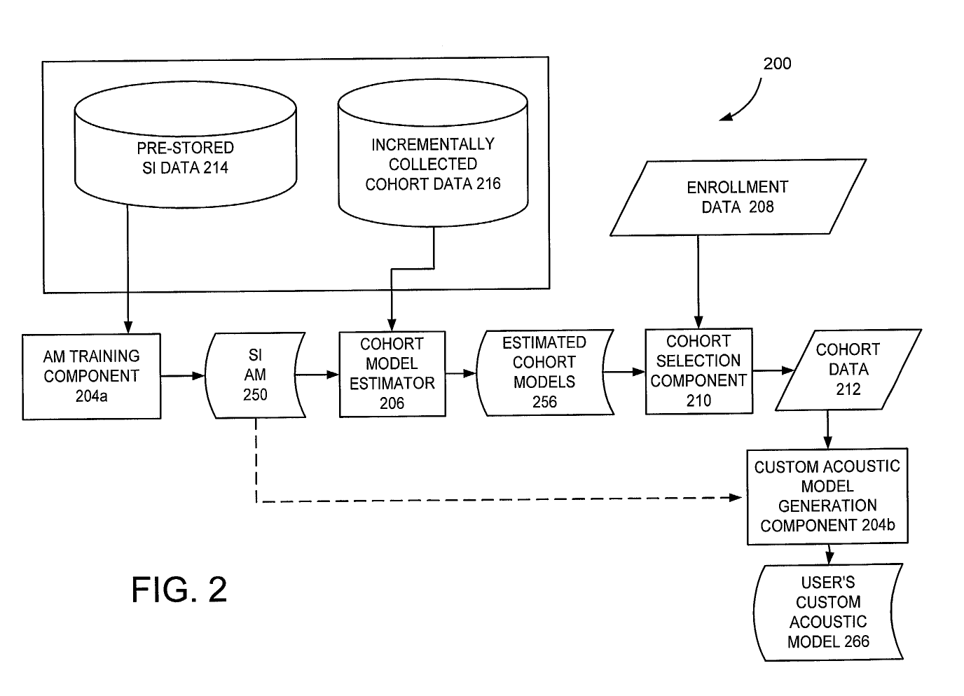

FIG. 2 is a more detailed block diagram of a system 200 in accordance with one embodiment of the present invention. System 200 can be used to generate a model customized to a user. As is stated above, the present description will proceed with respect to generating a customized acoustic model, customized to a user, for use in a speech recognition system. However, this is an exemplary description only.

System 200 includes data store 202, and acoustic model training components 204a and 204b. It should be noted that components 204a and 204b can be the same component used by different portions of system 200, or they can be different components. System 200 also includes cohort model estimator 206, enrollment data 208, cohort selection component 210, and cohort data 212 which is data corresponding to selected cohort models.

FIG. 2 also shows that data store 202 includes pre-stored speaker-independent data 214 and incrementally collected cohort data 216. Pre-stored speaker-independent data 214 may illustratively be one of a wide variety of commercially available data sets which includes acoustic data and transcriptions indicative of input utterances. Incrementally collected cohort data 216 can include, for example, data from additional speakers which is collected at a later time, and in addition to, speaker independent data 214. Enrollment data 208 is illustratively a set of three sentences (for example) collected from a user.

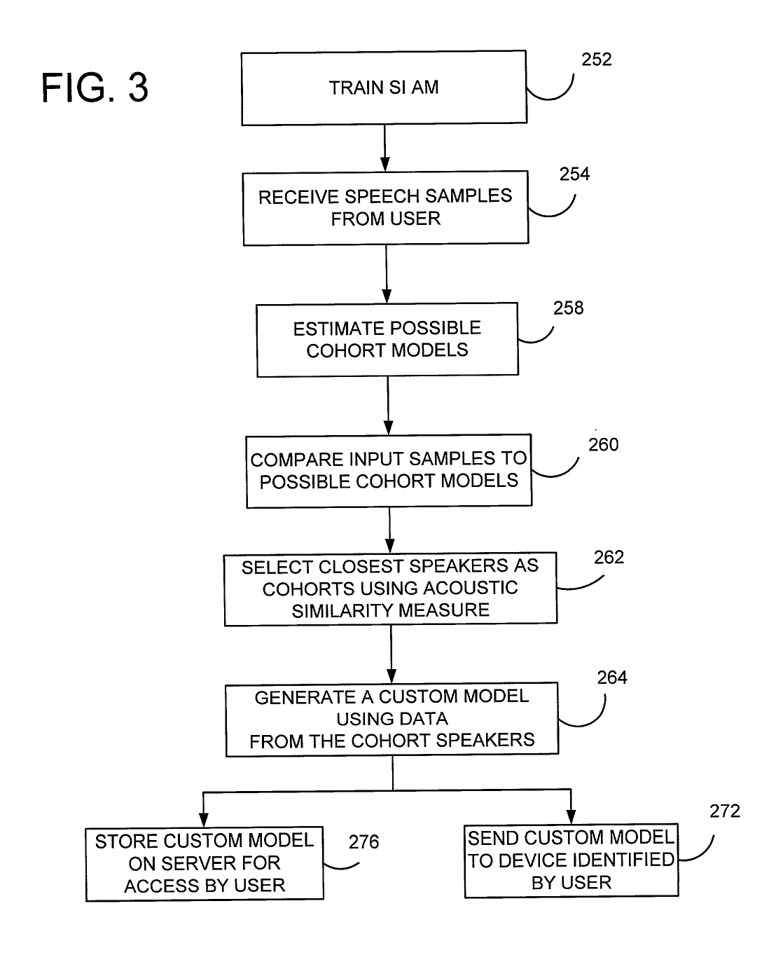

FIG. 3 is flow diagram that generally illustrates the overall operation of system 200 in accordance with one embodiment of the present invention. FIGS. 2 and 3 will be discussed in conjunction with one another. First, acoustic model training component 204a accesses pre-stored speaker-independent data 214 and trains a speaker-independent acoustic model 250. This is indicated by block 252 in FIG. 3. The user input speech samples are then received in the form of enrollment data 208. This is indicated by block 254 in FIG. 3. Illustratively, enrollment data 208 not only includes an acoustic representation of the user input of the enrollment data, but an accurate transcription of the enrollment data as well. The transcription can be obtained by directing the user to speak predetermined sentences and verifying that they spoke the sentences and thus knowing exactly what words correspond to the acoustic data. Alternatively, other methods of obtaining a transcription can be used as well. For example, the user speech input can be input to a speech recognition system to obtain the transcription.

Cohort model estimator 206 then accesses intermittently collected cohort data 216 which is data from a number of different speakers that are to be used as cohort speakers. Based on the speaker-independent acoustic model 250 and cohort data 216, cohort model estimator 206 estimates a plurality of different cohort models 256. Estimating the possible cohort models is indicated by block 258 in FIG. 3.

The possible cohort models 256 are provided to cohort selection component 210. Cohort selection component 210 compares the input samples (enrollment data 208) to the estimated cohort models 256. This is indicated by block 260 in FIG. 3.

Cohort selection component 210 then selects the speakers (the speakers corresponding to the estimated cohort models 256), that are closest to enrollment data 208, as cohorts using predetermined similarity measures. This is indicated by block 262 in FIG. 3. Cohort selection component 210 then outputs cohort data 212 which is illustratively the acoustic model parameters associated with the estimated cohort models 256 that were chosen as cohorts by cohort selection component 210.

Using cohort data 212, custom acoustic model generation component 204b generates a custom acoustic model 266. This is indicated by block 264 in FIG. 3. Component 204b then outputs the user's custom acoustic model 266.

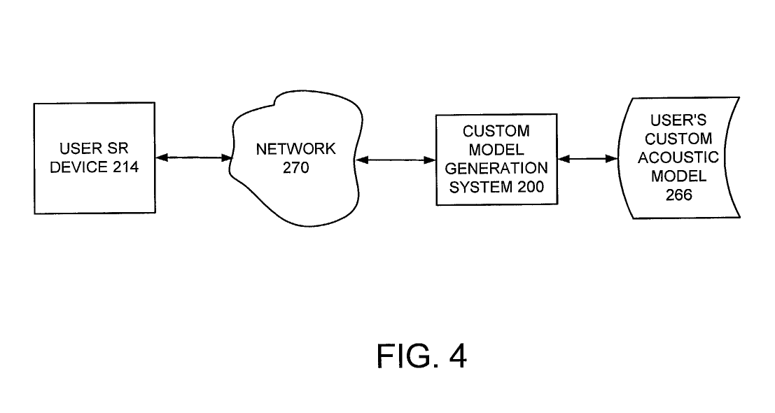

FIG. 4 illustrates different ways that system 200 can make the user's custom acoustic model 266 available to the user. For example, in one illustrative embodiment, system 200 simply stores the custom acoustic model 266 and makes it available to the user that corresponds to the model over a global network 270. In this way, it does not matter what type of device the user is using, so long as the user can access system 200, the user can access custom model 266. This is indicated by block 272 in FIG. 3.

Alternatively, system 200 can download custom model 266 to a pre-designated user device 274. User device 274 can, for example, be a personal digital assistant (PDA), the user's telephone, a lap-top computer, etc. Sending custom acoustic model 266 to user device 274 is indicated by block 276 in FIG. 3.

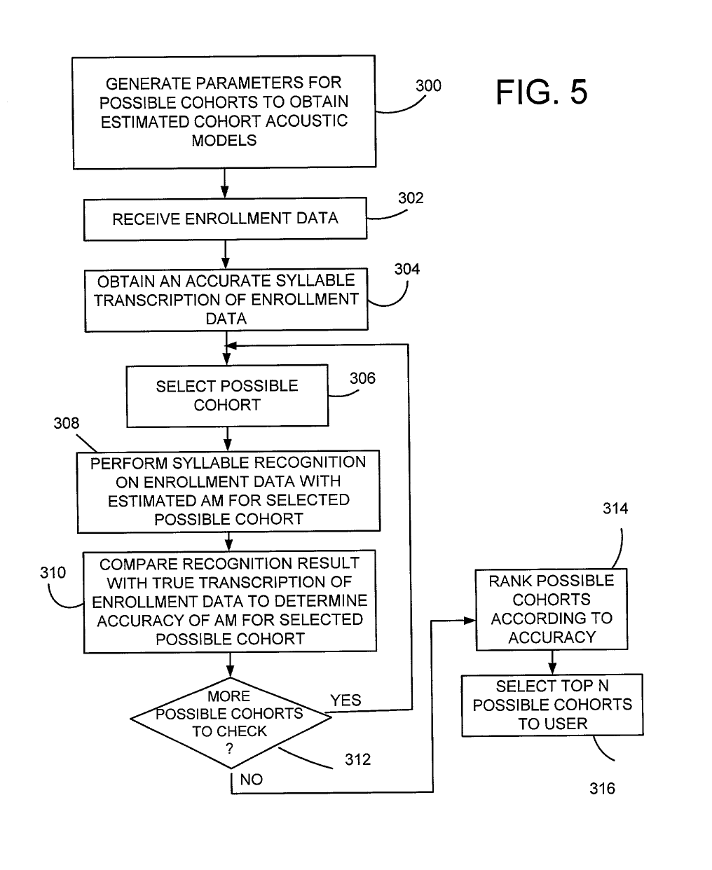

FIG. 5 is a flow diagram illustrating one embodiment of the operation of cohort selection component 210 in determining a similarity between enrollment data 208 and the estimated cohort models 256.

However, in one embodiment, prior to performing the cohort selection process, parameters of speaker adapted models for various possible cohort speakers are estimated using a maximum likelihood linear regression technique. This technique adapts speakers-independent acoustic model 250 using the data associated with the possible cohort speakers and the adapted models are considered the approximation of speaker-dependent models 256 for each of the possible cohort speakers. This is indicated by block 300 in FIG. 5.

After the estimated cohort models 256 are available to cohort selection component 210, or simultaneously, cohort selection component 210 receives enrollment data 208. This is indicated by block 302 in FIG. 5. Cohort selection component 210 also illustratively receives, within enrollment data 208, an accurate syllable transcription of the enrollment sample. Any suitable recognition system can be used to obtain the syllable recognition. In one example, a recognition system using only syllable trigram information and acoustic model is used to decode the enrollment data in order to obtain a high quality syllable transcription, without being influenced by the lexicon. Other systems can be used as well. In any case, an accurate syllable transcription of the enrollment data is received as indicated by block 304 in FIG. 5.

Next, cohort selection component 210 selects a possible cohort model 256. This is indicated by block 306. Cohort selection component 210 then performs syllable recognition on the enrollment data with the estimated cohort model 256 for the selected possible cohort. This is indicated by block 308. The recognition result generated from the selected estimated cohort model 256 is then compared against the true syllable transcription of the enrollment data in order to determine the accuracy of the estimated cohort model 256 in generating its syllable recognition. This is indicated by block 310 in FIG. 5.

Cohort selection component 210 then determines whether there are any additional estimated cohort models 256 which need to be considered. This is indicated by block 312. If so, processing continues at block 306. If not, however, then all of the estimated cohort models 256 which have been checked are ranked according to the accuracy they exhibited in the syllable recognition process. This is indicated by block 314 in FIG. 5.

The top N possible cohort models 256 are selected as the actual cohorts to the user, and the data associated with those cohorts (e.g., the estimated cohort models 256) are output as cohort data 212. This is indicated by block 316 in FIG. 5.

While cohort selection can be performed based on the syllable recognition alone, it can also be performed based on recognition likelihood or based on a combination of both syllable recognition and likelihood or based on other methods.

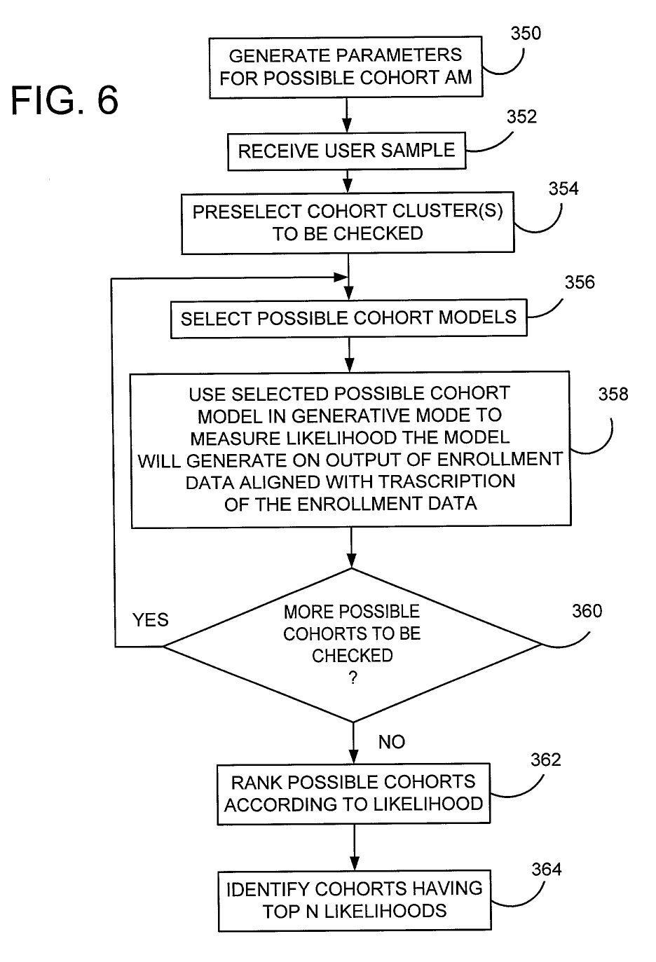

FIG. 6 is flow diagram which illustrates the operation of cohort selection component 210 in accordance with another embodiment of the present invention using recognition likelihood. The parameters for possible cohorts are generated and the estimated cohort models 256 are generated as indicated by block 350. Similarly, the enrollment data 208 is received as indicated by block 352. These steps are similar to blocks 300 and 302 in FIG. 5.

Next, cohort selection component 210 can pre-select clusters of cohort models 256 which are to be checked. For example, if the user is identified as a male, then cohort selection component 210 can do a preliminary selection of only estimated cohort models 256 which were generated using male speakers. This can save time in performing cohort selection. This is indication by optional block 354 in FIG. 5.

Cohort selection component 210 then selects one of the estimated cohort models 256 for processing. This is indicated by block 356 in FIG. 6. Cohort selection component 210 then uses the selected possible cohort acoustic model 256 in a generative mode to measure a likelihood that the selected model 256 will generate an output of the enrollment data aligned against the transcription of the enrollment data. This is indicated by block 358. This likelihood measure essentially measures how acoustically similar the speaker is who generated cohort model 256 to the user of the system who generated the enrollment data 208. The likelihood measure can be obtained using any known technique as well.

Selection component 210 then determines whether there are any more estimated cohort models 256 which need to be considered. This is indicated by block 360 in FIG. 6. If so, processing continues at block 356. If not, however, then cohort selection component 210 ranks the estimated cohort models 256 which have been processed according to the likelihood measured at block 358. This is indicated by block 362. Cohort selection component 210 then identifies, as actual cohort models, the top N estimated cohort models 256 as ranked in block 362. This is indicated by block 364.

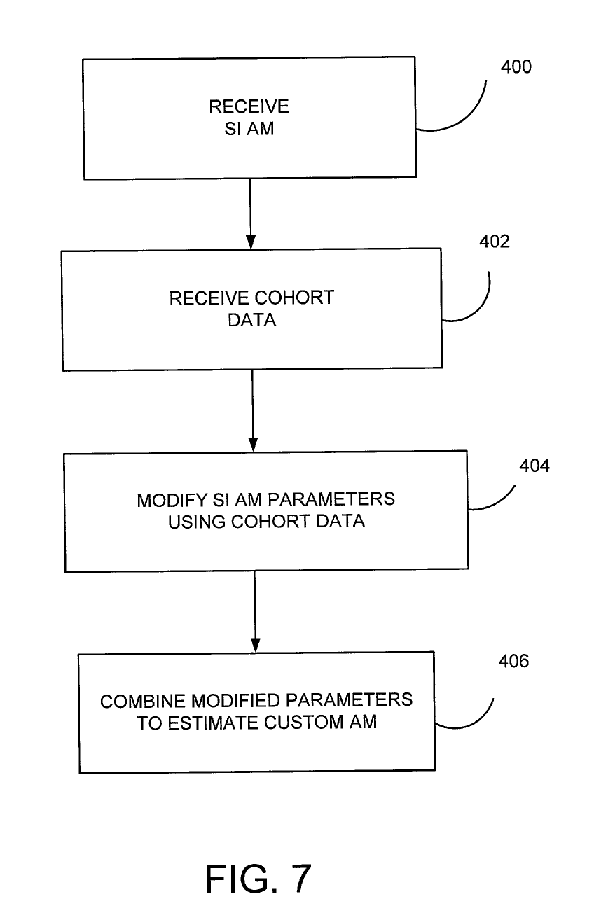

FIG. 7 is flow diagram which illustrates one embodiment of the operation of custom acoustic model generation component 204b. In accordance with the embodiment shown in FIG. 6, acoustic model generation component 204b first receives the speaker independent acoustic model 250 and the cohort data 212. This is indicated by blocks 400 and 402 in FIG. 7. Acoustic model generation component 204b then modifies the parameters in the speaker-independent acoustic model 250 using the parameters in the estimated cohort models 256 which are included in cohort data 212. This is indicated by block 404 in FIG. 7.

Component 204b then combines the modified parameters to estimate the custom acoustic model 266. This is indicated by block 406 in FIG. 7. Model adaptation can be performed using any known techniques as well.

This type of single-pass re-estimation procedure, which is conditioned on speaker-independent acoustic model 250, has several advantages. First, during the re-estimation process, different weights can be easily added on the feature vectors of the different speakers according to their degrees of similarity to the test speaker. Thus, all selected cohort speakers need not be weighted the same. In addition, the process of re-estimation updates the value of each parameter instead of only means, as in most adaptations schemes. Further, since the posteriori probability of occupying the m'th mixture component, conditioned on the speaker-independent model, at time t for the r'th observation of the i th cohort, denoted by Lₘ^{i,r} (t) has been computed and can thus be stored in advance, the one-pass re-estimation procedure need not consume many computational resources. The modified estimation formula can now be expressed as follows:

$$\begin{matrix}{\tilde{μ}}_{m} = {\sum }_{i = 1}^{N} {\sum }_{r = 1}^{{R}_{i}} {\sum }_{t = 1}^{{T}_{r}} ( {L}_{m}^{i , r} ( t ) \cdot {O}^{i , r} ( t ) ) / {\sum }_{i = 1}^{N} {\sum }_{r = 1}^{{R}_{i}} {\sum }_{t = 1}^{{T}_{r}} {L}_{m}^{i , r} ( t ) \\ = {\sum }_{ i = 1}^{N} {Q}_{m}^{i} / {\sum }_{i = 1}^{N} {L}_{m}^{i , r}\end{matrix} where \\ \begin{matrix}{L}_{m}^{i} = {\sum }_{r = 1}^{{R}_{i}} {\sum }_{t = 1}^{{T}_{r}} {L}_{m}^{i , r} ( t ) ; \\ {Q}_{m}^{i} = {\sum }_{r = 1}^{{R}_{i}} {\sum }_{t = 1}^{{T}_{r}} {L}_{m}^{i , r} ( t ) \cdot {{O}^{i , r } ( t )}^{}\end{matrix} \qquad Eq . 1$$

where Lⁱₘ and Qⁱₘ can be stored in advance;

N represents speakers (or cohorts):

R represents observations;

T represents time;

O^{i,r}(t) is the observation vector of the r'th observation of the i'th speaker at time t; and ũₘ is the estimated mean vector of the m'th mixture component of the speaker.

The variance matrix and the mixture weight of the m'th mixture component can also be estimated in a similar way.

It should also be noted that other methods can be used to customize the acoustic model at component 204b. For example, if a sufficient number of cohort models 256 have been selected for cohort data 212, then the user custom acoustic model 266 can simply be trained from scratch using cohort data 212. Similarly, simply the closest estimated cohort model 256 can be chosen as the user's custom acoustic model 266.

It should also be noted that the present invention can be used to not only customize the model to the user, but to the user's equipment as well. For instance, different microphones exhibit different acoustic characteristics in which different frequencies are attenuated differently. These characteristics can be used to adapt the custom model, or they can be used during creation of the custom model in the same way as the cohort data. This yields performance specifically tuned to a user and the user's equipment.

Although the present invention has been described with reference to particular embodiments, workers skilled in the art will recognize that changes may be made in form and detail without departing from the spirit and scope of the invention.

What is claimed is:

1. A method of training a custom user input recognition model for a user, comprising:
receiving a user-independent (UI) data corpus;
receiving a user enrollment input;
identifying cohort models from a set of possible cohort models based on a similarity measure indicative of similarity between the possible cohort models and the user enrollment input, at least some of the possible cohort models being derived from incrementally collected cohort data, collected in addition to the UI data corpus; and
generating the custom UI recognition model based on the UI data corpus and the cohort models.

2. The method of claim 1 wherein the UI data corpus comprises a speaker-independent (SI) data corpus, the user enrollment input is a user speech input and the cohort models are cohort acoustic models.

3. The method of claim 2 wherein generating the custom user input recognition model comprises:
generating a user acoustic model (AM).

4. The method of claim 3 wherein generating a user AM comprises:
training the user AM from data associated with the cohort AMs.

5. The method of claim 3 and further comprising:
generating a SI AM from the SI data corpus.

6. The method of claim 5 wherein generating a user AM comprises:
re-estimating parameters associated with the SI AM based on parameters associated with the cohort AMs.

7. The method of claim 3 and further comprising:
prior to identifying cohort AMs, generating an estimation of a cohort speaker-dependent (SD) AM as each possible cohort model.

8. The method of claim 7 wherein identifying cohort AMs comprises:
selecting a possible cohort SD AM;
measuring a likelihood that the selected possible cohort SD AM will generate the user enrollment input; and
identifying the cohort SD AMs based on the likelihood.

9. The method of claim 8 wherein measuring a likelihood comprises:
using the selected possible cohort SD AM to generate the user enrollment data aligned with a transcription of the user enrollment data.

10. The method of claim 8 wherein identifying cohort SD AMs comprises:
obtaining a syllable transcription of the user enrollment input;
decoding the user enrollment input with the selected possible cohort SD AM; and
measuring syllable accuracy of the decoded enrollment data.

11. The method of claim 10 wherein identifying cohort SD AMs comprises:
identifying the cohort SD AMs based on the phonetic units recognition accuracy.

12. The method of claim 10 wherein measuring phonetic units recognition accuracy comprises:
aligning the decoded enrollment data with the phonetics unit transcription of the enrollment data.

13. The method of claim 1 wherein the enrollment data comprises a user handwriting input, wherein the cohort models comprise cohort handwriting recognition models, and wherein generating the custom user input recognition model comprises:
generating a custom handwriting recognition model.

14. A system for generating a custom user input recognition model, comprising:
an estimated model generator generating estimated possible cohort models from intermittently collected cohort data;
a cohort selector selecting cohort models from the possible cohort models based on user enrollment data; and
a custom model generator generating the custom user input recognition model based on data corresponding to the cohort model.

15. The system of claim 14 wherein the cohort model comprises cohort acoustic models and the custom user input recognition model comprises a custom acoustic model (AM).

16. The system of claim 15 wherein the cohort selector is configured to operate the possible cohort models in a generative mode to measure a likelihood that the possible cohort models will generate the enrollment data.

17. The system in claim 16 wherein the cohort selector is configured to receive a phonetic unit transcription of the enrollment input.

18. The system of claim 17 wherein the cohort selector is configured to decode the enrollment data and measure an accuracy of the decoded data relative to the phonetic unit transcription.

19. The system of claim 18 and further comprising a speaker-independent (SI) AM.

20. The system of claim 19 wherein the custom model generator is configured to generate the custom AM by adapting parameters of the SI AM based on parameters of the cohort AMs.
